(19) United States
(12) Patent Application Publication
(10) Pub. No.: US 2015/0147231 A1
(43) Pub. Date: May 28, 2015

(54) OPTOCHEMICAL SENSOR

(71) Applicant: Joanneum Research Forschungsgesellschaft mbH, Graz (AT)

(72) Inventors: Martin Tscherner, Graz (AT); Volker Ribitsch, Graz (AT)

(21) Appl. No.: 14/405,912

(22) PCT Filed: Jun. 5, 2013
(86) PCT No.: PCT/AT2013/000096

§ 371 Date: Dec. 5, 2014

(30) Foreign Application Priority Data
Jun. 6, 2012 (AT) A 650/2012

(51) Int. Cl. G01N 21/77

(52) U.S. Cl. CPC G01N 21/77; G01N 21/7703; G01N 2021/773; G01N 2021/7786; G01N 2021/7793; G01N 2021/775
USPC 422/82.07

(57) ABSTRACT

The invention relates to an optochemical sensor comprising a polymer matrix which is applied to a substrate and which is doped with a luminescent colorant, the emissivity of which can be modified after excitation with electromagnetic radiation by substances to be detected such as gaseous or dissolved O₂, SO₂, H₂O₂, CO₂, nitrogen oxides and halogenated hydrocarbons, which polymer matrix forms a sensor layer that is also covered by an optical insulating and protective layer which can be permeated by the substance to be analysed. In the optochemical sensor, the sensor layer is formed from a layer which has an insular sensor element or a plurality of mutually separated sensor elements, the at least one sensor element being covered by a non-doped polymer matrix which chemically corresponds to the polymer matrix of the sensor layer.

The present invention relates to an optochemical sensor including a polymer matrix applied on a substrate and doped with a luminescent dye whose emissivity upon excitation with electromagnetic radiation by substances to be detected, such as gaseous or dissolved O₂, SO₂, H₂O₂, CO₂, nitrogen oxides, halogenated hydrocarbons, is variable, and which forms a sensor layer, which is covered by an optical protecting, supporting and/or insulating layer permeable for the substance to be analyzed.

Sensors for measuring the concentrations of specific substances like gases in solutions or solids either operate electrochemically, in which case they involve the disadvantage of consuming a portion of the gas to be determined for the quantitative detection of the substance to be determined, thus falsifying the measurement, or, alternatively, optochemical sensors have recently been developed, which are characterized in that they will not change the composition of the analyte over time but reveal the quantitative detection of the concentration of a substance to be determined, or gas to be determined, only by an extinction of the luminescence of the luminescent substance contained in the sensor. In doing so, characteristic parameters such as the intensity of the luminescence, the phase shift of the luminescence signal, or even the decay time of the luminescence, are verified so as to enable a quantitative detection of the substance to be measured by a comparison of the luminescence signal with a calibration function.

Early optochemical sensors such as those described, for instance, in EP-A 0 550 424 or in EP-A 0 601 816 have used special polymers in which gases like oxygen and CO are well soluble, in order to achieve a quantitative detection of the gases via the solubilities of the gases in the polymer. Those known sensors involve the drawback that they cannot be used several times and cannot be sterilized because of the polymers used in such sensors, in particular where elevated temperatures are applied, thus being hardly or not at all usable in biological materials.

From DE 10 2006 025 470, a fluorescence sensor for detecting gas compositions has become known, in which a layer applied on a substrate and containing a fluorescent dye is covered by a gas-permeable diffusion layer.

From EP 0 109 959 A2, a sensor element for determining the oxygen content of a sample can be taken, in which a substrate formed by a cured silicone polymer comprises the indicator substance bound in solubilized form, and which substrate is covered by a further polymer layer having a low light transmission on its side facing a sample.

From WO 2005/100957, a luminescence sensor for determining and/or monitoring an analyte contained in a fluid process medium can be taken, in which a luminescent substance getting into contact with the analyte, or gaseous process medium, is embedded in a porous carrier structure and covered by at least one protecting layer.

From EP-B 1 114 309, a multi-use optochemical sensor has already become known, in which a luminescent dye contained in a polymer matrix is excited to electromagnetic radiation, whose emissivity changes after its excitation so as to enable a quantitative measurement. The polymers or polymer matrix used in that optochemical sensor are formed by at least one polymer without any plasticizer added, wherein the selected polymer has a glass transition temperature of above 140° C., thus enabling the sensor to be both sterilized and applied in biological material, and used several times. That known optochemical sensor involves the disadvantage that a relatively large amount of luminescent dye has to be used in the sensor in order to obtain reproducible measurements even after multiple uses of the sensor, and that the sensor is extremely sensitive to mechanical influences, and hence in most cases already damaged after a few measurements so as to appear unsuitable for any further use.

The present invention aims to provide an optochemical sensor in which the tendency to the formation of aggregates, or the migration of the luminescent dye, is strongly reduced and which enables the achievement of consistent reproducible results even a multiple reuses. The invention further aims to prevent any attenuation of the measured signal, even after a plurality of measurements, by a special construction of the sensor.

To solve this object, the optochemical sensor according to the present invention is characterized in that the sensor layer is formed by a layer comprising at least one insular sensor element, which at least one insular sensor element is covered by an undoped polymer matrix chemically corresponding to the polymer matrix of the sensor layer, and that a further layer corresponding to the undoped polymer matrix is provided between the substrate and the layer comprising the at least one sensor element. In that the sensor layer is formed by a layer that is covered by a cover layer corresponding to the polymer matrix, it has become possible to embed the sensor element in the sensor layer as far as possible so as to largely prevent bleeding of the luminescent dye even after multiple uses and at a sterilization of the sensor.

In order to enclose the at least one sensitive sensor element possibly on all sides, and hence ensure reproducible measurements, the optochemical sensor according to the invention is devised such that a further layer corresponding to the undoped polymer matrix is provided between the substrate and the layer comprising the sensor element. By the all-side embedment of the sensitive sensor layer, or sensitive luminescent dyes, in a polymer matrix or polymer layer, it will be ensured that, on the one hand, the selective choice of the polymer forming the polymer matrix and permeable for the substance to be analyzed will provide a safe and reliable measurement of the substances to be analyzed and, on the other hand, the bleeding or washing-out or inactivation of the sensitive luminescent dyes will, at the same time, be safely avoided even after a plurality of measurements or repeated measurements. Finally, a migration of the luminescent dyes into surrounding layers will be prevented. Such a prevention of the migration into surrounding layers is of importance, in particular because the luminescent dye would be present in the same in a physically and chemically different environment and would behave differently in terms of analyte sensitivity, thus causing a falsification of the measurement, for instance due to the formation of a “foreign” dye molecule population”.

It was, furthermore, found that an aggregate formation of the dye molecules, and hence the formation of a “foreign” dye molecule population, or a self-extinction, i.e. no sensitivity to the analytes to be measured, might preferably occur on the interfaces between the matrix polymer forming the polymer matrix and further materials chemically different from the matrix polymer. In the event of such an aggregate formation, the behavior of the sensor could, moreover, be only insufficiently described by the known characteristic function of the Stern-Volmer false light model, and a numerical curve fitting of calibration points could only be achieved by unnecessarily large residual variances. By contrast, the configuration according to the invention is successful in avoiding that dye molecules change over to a “parasitic” population, and it has thus further become possible to precisely describe the characteristic by the Stern-Volmer false light equation.

According to a further development of the invention, the sensor layer is formed by a layer comprising a plurality of mutually separate sensor elements, which sensor elements are covered by an undoped polymer matrix chemically corresponding to the polymer matrix of the sensor layer. In that the sensor layer is formed by a layer in which a plurality of mutually separate sensor elements are contained, it has become possible to embed the sensor elements as far as possible in the sensor layer such that washing-out of the luminescent dyes will be largely impeded even after multiples uses and at a sterilization of the sensor and the amount of used luminescent dye will, at the same time, be minimized. In that, furthermore, the sensor elements are covered by an undoped polymer matrix chemically corresponding to the polymer matrix of the sensor elements, it has additionally become possible to form a protecting layer above the sensitive sensor elements so as to enable a further increase in the number of use cycles of the sensor elements owing to the protection of the measuring layer from damage or destruction and, at the same time, also safely prevent an attenuation of the measured signals caused by washed-out or chemically changed luminescent dyes.

Due to the mutual separation of the sensor elements, it has, furthermore, become possible to form areas between the individual sensor elements, in which areas the direct contact of a cover layer with the substrate will be provided to significantly increase, in particular, the mechanical stability of the sensor over conventional products, in particular where the cover layer is formed by a material that does not correspond to the polymer matrix.

In order to further increase the number of cycles when reusing the optochemical sensor according to the invention, the sensor according to the invention is further developed to the effect that the two layers of undoped polymer matrix are chemically and/or physically interconnected in the region encompassing the at least one sensor element. Due to the chemical and/or physical connection of the two layers of undoped polymer matrix, the sensor element(s) will be completely and, in particular, tightly enclosed by the undoped polymer matrix such that any decrease of activity caused by inadvertent washing-out or bleeding of the luminescent dye will be safely impeded and the number of cycles of the sensor will thus be further increased.

As in correspondence with a possible further development of the invention, the optochemical sensor is further designed in such a manner that the plurality of sensor elements is formed as a field of sensor elements comprising mutually equal distances, in particular punctiform sensor elements. In that the optochemical sensor is formed by arranging a plurality of sensor elements as a field of sensor elements comprising mutually equal distances, it has become possible to not only minimize the amount of luminescent dye employed but, at the same time, also provide a large sensor or measuring surface for reliably achieving quantitative and reproducible measuring results.

According to a further development of the invention, the optochemical sensor is characterized in that the field of sensor elements is comprised of at least two groups of sensor elements different in terms of the amount and type of the doping with luminescent dye. In that the field of sensor elements is comprised of at least two different groups of sensor elements, said groups differing in terms of the type of the doping with luminescent dye or the type of the matrix polymer, it has become possible to quantitatively detect, at one and the same time, by one and the same sensor, a plurality of substances to be detected, such as gaseous or dissolved oxygen, SO₂, H₂O₂, CO₂, nitrogen oxides, halogenated hydrocarbons and the like. Due to the differences in terms of matrix polymer type and luminescent dye type, differently intense signals will simultaneously be obtained for one and the same substance to be detected so as to enable, for instance, the quantitative detection by one and the same sensor of a wide spectrum of concentrations of the dissolved substances.

In that, as is known per se, the optochemical sensor is covered by a supporting, protecting and/or insulating layer selected from macro- or micro-porous polytetrafluoroethylene membranes or nylon membranes, in particular having pore sizes ranging between 0.1 μm and 160 μm, preferably 0.1 μm and 30 μm, carbon fiber fabrics, special textile fiber fabrics, semi-permeable membranes of soluble polymers, in particular soluble, perfluorinated polymers, or a combination thereof, it has, moreover, become possible to provide a mechanical and chemical protection of the sensor surface. The configuration as a porous or semi-permeable layer will, however, not impede the penetration to the sensor surface of the substance to be analyzed, and will ensure the rapid adjustment of the measuring value. Furthermore, it will be possible by such an insulating and/or protecting layer to shield the sensor from environmental influences or ambient light.

In order to obtain a dense material composite and, in particular, further increase the lifetime of the optochemical sensor, and hence the number of use cycles, the sensor according to the invention is further developed to the effect that the supporting, protecting and/or insulating layer is at least partially embedded in the undoped polymer matrix comprising the sensor elements so as to, in particular, prevent a destruction of the polymer matrix.

In particular, in order to safely prevent any inadvertent excitation of the luminescent dye contained in the sensor elements by extraneous light or foreign chemical matter, the sensor according to the invention is further developed to the effect that a cover layer is provided above the undoped polymer matrix or the optical supporting, protecting and/or insulating layer, which cover layer, according to a preferred further development, is comprised of two cover layers, and that the supporting, protecting and/or insulating layer is disposed between the cover layers. By pigmenting the cover layer with soot, it will be possible, in particular during a measurement or during a plurality of successive, consecutive measurements, to prevent any inadvertent excitation by extraneous light, and hence any falsification of the measured signal. Particularly preferred characteristics and, in particular, both a mechanical support and a protection against chemical attacks, and an optical insulation, will be achieved if, as in correspondence with a further development of the invention, the cover layer is selected from silicones, partially fluorinated silicones and perfluorosilicones, coatings of soluble polymers, in particular soluble, perfluorinated polymers, or a combination thereof. By the cover layer being comprised of two layers, it has become possible to safely and completely embed in the cover layer the supporting, protecting and/or insulating layer, which will frequently exhibit poor adhesiveness, so as to safely prevent the inadvertent detachment of the insulating layer, or even the detachment of the sensor layer from the substrate.

In that, as in correspondence with a preferred further development of the invention, the outer cover layer is pigmented with soot and the inner cover layer is pigmented with TiO₂, it has, on the one hand, become possible to achieve the best possible backscatter of the excitation and luminescence light and, on the other hand, safely prevent any inadvertent excitation with extraneous light.

In a preferred further development of the invention, the base material used for the formation of the cover layers is selected from a polymer corresponding to the polymer matrix, which may be pigmented with TiO₂ and/or soot for the formation of the cover layers. By the cover layers being comprised of a material corresponding to the polymer matrix, it has become possible to provide a chemically and physically particularly stable connection between the cover layers and the sensor layer, or undoped polymer matrix. As a result, the cover layer and the sensor layer, moreover, have almost identical thermal expansion behaviors and swelling behaviors in liquid media, which is why shearing forces between the layers as may occur by stresses due to temperature changes or when contacting different liquid media will be effectively avoided, and the tendency to mechanically induced delamination will thus be suppressed. The number of successive measuring cycles can consequently be further increased, in particular after repeatedly applied sterilization cycles.

According to the invention, the sensor layer, the undoped polymer matrix and the cover layer are applied to the substrate, or the already existing layers located therebelow, from a polymer solution one after the other using a suitable deposition method, e.g. screen-printing. In that the layers are formed from a polymer solution from which the solvent will rapidly evaporate after deposition, it has become possible to incipiently dissolve the surface of the underlying layer, whereupon the incipiently dissolved layer and the newly applied layer will dry simultaneously and collectively. The layers thus virtually fuse together, providing a chemically and physically particularly stable adherence between the individual layers so as to effectively exclude any chance of delamination between the layers during the use or sterilization of the sensor.

In order to also further enhance the adherence to the substrate, a preferred further development of the invention contemplates that an applied substrate having surface structures with undercuts is employed. By such a mode of operation, the layers to be deposited will completely enclose the roughness structures on all sides after coating so as to provide a stable mechanical adherence to the substrate, which will safely suppress any tendency to delamination even at frequently repeated sterilization procedures and after a plurality of measurements.

In order to ensure that only the side comprising a supporting, protecting and/or insulating layer of the sensor will be contacted by the measuring medium, and to further avoid any damage to the sensor during handling, the sensor is preferably further developed such that the sensor is held in a mounting cap, which is preferably provided with clamping or retaining elements holding the sensor in such a manner as to not only prevent it from inadvertently falling out of the mounting capacity but also enable it to be replaced whenever necessary. Thereby, the penetration of measuring medium or cleansing agent between the substrate or carrier and the sensor layer, and hence the detachment of the sensor from the substrate, will, in particular, be prevented.

For the proper functioning of the optochemical sensor, the mounting cap is, moreover, devised such that it is provided with a fixing element for an optical waveguide, which forms the connection between the sensor and the measuring electronics.

A particularly long-lived and frequently reusable sensor can be obtained according to the present invention in that at least the polymer matrix of the sensor layer is comprised of soluble, amorphous, perfluorinated polymers such as polymers of substituted perfluoro-2-methylene-1,3-dioxolanes or perfluoro-(4-vinyloxy-1-butene), yet in particular poly[2,2,4-trifluoro-5-trifluoromethoxy-1,3-dioxol-co-tetrafluoroethylene]. The longevity of such a sensor can be further enhanced in that soluble, amorphous, perfluorinated polymers such as polymers of substituted perfluoro-2-methylene-1,3-dioxolanes or perfluoro-(4-vinyloxy-1-butene), yet in particular poly[2,2,4-trifluoro-5-trifluoromethoxy-1,3-dioxol-co-tetrafluoroethylene], are selected as base material for the cover layers, which can be doped with TiO₂ or soot. In another preferred further development, a polymer that is identical with the polymer matrix is selected as base material for the cover layers.

In the following, the invention will be explained in more detail by way of exemplary embodiments illustrated in the drawing. Therein:

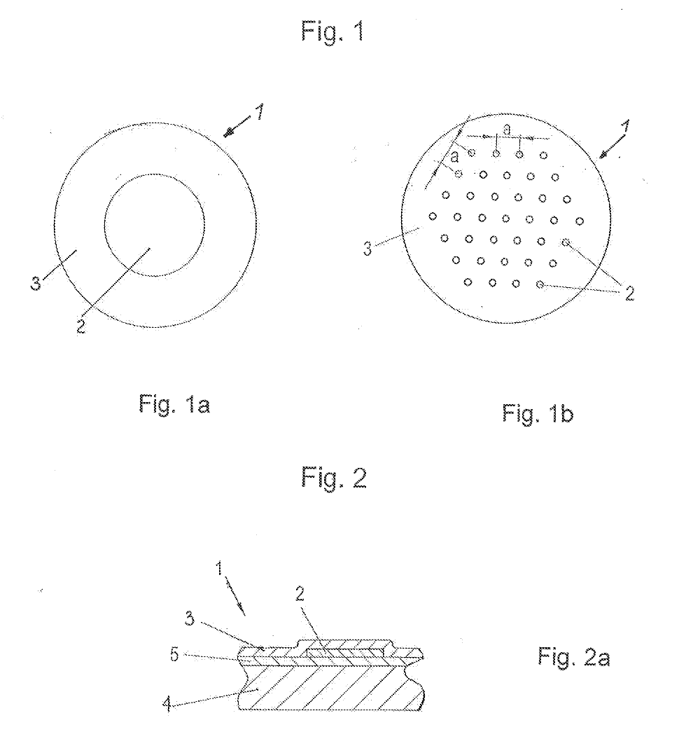

FIG. 1 is a top view of an optochemical sensor according to the invention;

FIG. 1a shows an optochemical sensor whose sensor layer is formed by a sensor element;

FIG. 1b shows an optochemical sensor whose sensor layer is comprised of plurality of sensor elements;

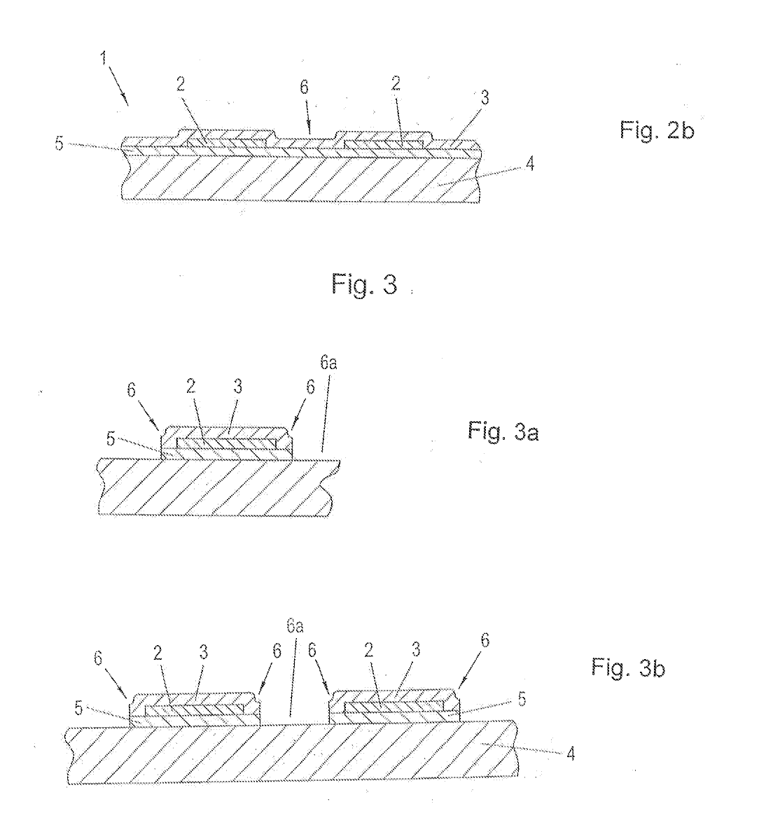

FIG. 2 is a section through an optochemical sensor according to FIG. 1;

FIG. 2a is a section through the optochemical sensor according to FIG. 1a;

FIG. 2b is a section through the optochemical sensor according to FIG. 1b;

FIG. 3 depicts another configuration of a section through an optochemical sensor according to the invention;

FIG. 3a is a section to an optochemical sensor whose sensor layer is formed by a sensor element;

FIG. 3b is a section to an optochemical sensor whose sensor layer is formed by a plurality of sensor elements;

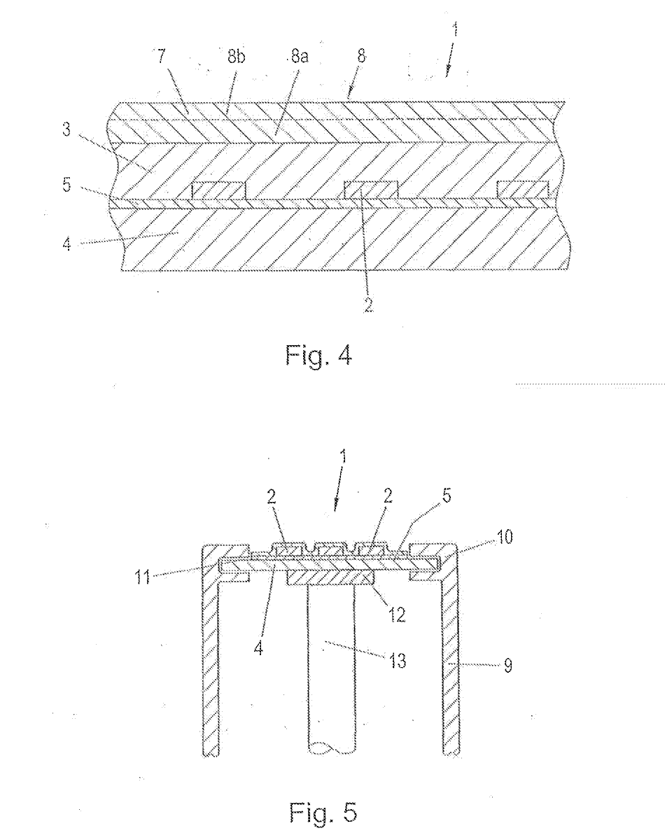

FIG. 4 illustrates a section through a further development of the optochemical sensor according to the invention;

FIG. 5 is a section through the optochemical sensor according to the invention in a retaining element; and

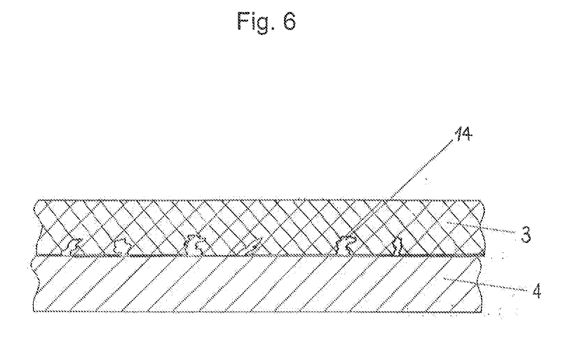

FIG. 6 depicts a schematic illustration of a roughened substrate.

In FIG. 1a, an optochemical sensor is denoted by 1, whose sensor layer is formed by a sensor element 2 embedded in a polymer matrix 3. By contrast, in FIG. 1b an optochemical sensor is denoted by 1, whose sensor layer is comprised of a plurality of sensor elements 2. The sensor element(s) 2, which are designed as punctiform or two-dimensional sensor elements in the illustrations according to FIGS. 1a and 1b and, when comprised of a plurality of sensor elements, have equal distances a from one another, are embedded in a polymer matrix 3 formed by the same polymer material as the sensor elements 2, yet the sensor elements 2 are additionally doped with a luminescent dye.

In the context of FIGS. 1a and 1b, it goes without saying that the sensor elements 2 of the optochemical sensor 1, besides the illustrated circular shape, may have any other desired shape such as an elliptical, angular or the like shape, with both the distance a between the sensor elements 2 and the number of the latter within the optochemical sensor 1 being variable at will.

Finally, the sensor elements 2 may also be doped with different or mutually different luminescent dyes or comprised of different matrix materials in order to simultaneously enable either different intensities of the measured signals or the detection of a plurality of gaseous or dissolved substances in a sample.

From FIG. 2, which depicts a section through the optochemical sensor 1 according to FIG. 1, it is apparent that the polymer matrix 3 is applied on a substrate 4, which is, for instance, comprised of an optically inactive, light-permeable material such as polymers that are insoluble in, or resistant to, acids, bases and organic solvents, e.g. PET, polycarbonate, polymethacrylate or glass. In the illustration according to FIG. 2, a base layer 5 comprised of the same material as the layer 3 is applied on the substrate 4, which polymer material is not doped with a luminescent dye. The base layer 5 is formed either as a continuous layer on the substrate 4 or, in the event of a plurality of sensor elements, in the form of layer elements insularly distributed on the substrate 4 and slightly surmounting the sensor elements 2 on all sides in terms of size, as is illustrated in FIG. 3. When comprised of a plurality of sensor elements 2, the latter are applied in an equidistant fashion on the layer or base layer 5, and the sensor elements 2 are again covered by the polymer matrix 3 in which no luminescent dye is integrated. The layer 3 in this case is configured to be in direct contact with the base layer 5 each between the sensor elements 2, and chemically and/or physically connected to the base layer 5 in the region 6 around the sensor element or between the sensor elements 2. By such a configuration, it is possible to not only completely cover the sensor elements 2 and hence safely prevent bleeding of the sensor elements 2, in particular of the luminescent dye contained in the sensor elements 2, but to also make each sensor element 2 a measuring device that is independent of the other sensor elements 2. By arranging the polymer matrix on the sensor, it has, moreover, become possible to protect the sensor itself from chemical attacks, since it is reasonable and important, in particular in a frequent field of application of optochemical sensors, i.e. the monitoring of food processes, to protect the polymer matrix from commonly used disinfectants such as, e.g. peroxyacetic acid, phosphoric acid, nitric acid, hydrochloric acid, soda lye or hypochlorite. Furthermore, the arrangement of the polymer matrix will, for instance, safely prevent the oxidation of the sensor dye.

The configuration according to FIG. 2 can, however, also be devised such that the sensor elements 2 are in direct contact with the substrate 4, in which case the polymer matrix or layer 3 is physically and/or chemically connected to the substrate 4 between the sensor elements 2 in direct contact with the former, in order to again prevent any inadvertent leakage or washing-out of luminescent dye from the sensor elements 2.

In the illustration according to FIG. 4, in which the reference numerals of the preceding Figures have been retained where possible, a base layer 5 is again applied on the substrate 4 and the sensor elements 2 are again embedded in the polymer matrix 3. In order to both impart an enhanced strength to the sensor 1 according to FIG. 3 and safely protect both the polymer matrix 3 and the sensor elements 2 from inadvertent damage, a schematically illustrated supporting, protecting and/or insulating layer 7 made, for instance, of macro- or micro-porous polytetrafluoroethylene is applied on the polymer matrix 3. Finally, a cover layer 8 is applied above and below the insulating and/or supporting layer 7. The cover layer 8 in this case is formed by a polymer pigmented with soot in order to prevent any inadvertent excitation of the sensor by extraneous light.

In a construction of the sensor 1 according to FIG. 4, areas 6a of the substrate 4 remain free at regular intervals, with a direct physical or chemical connection of the cover layer 8 to the substrate 4 being provided in these areas 6a. Such a direct connection will significantly increase the mechanical stability of the sensor and its layered structure, respectively, and, in particular, reduce the tendency of the sensor to delamination.

For a particularly good maintenance of the supporting, protecting and/or insulating layer 7 on the sensor, the cover layer 8, according to a variant of the invention, is configured to be divided into two parts, wherein the part of the cover layer 8 facing the sensor is the cover layer 8a pigmented with TiO₂, the protecting and/or insulation layer is disposed on the cover layer 8a, and the second part of the cover layer, i.e. the cover layer 8b, is disposed above the supporting, protecting and/or insulating layer 7 and consists of the same base material as the cover layer 8a, yet is pigmented with soot instead. Such a configuration enables the achievement of, on the one hand, an excellent backscatter of the excitation and luminescence light by the TiO₂, thus for instance reducing the amount of used fluorescent dye, and, on the other hand, a good optical insulation by the soot. In that, for instance, layer 7 is embedded in layer 8, a mechanically integer and stable material composite is obtained.

In order to be able to perform a particularly efficient measurement using the optochemical sensor 1 according to the invention, the base layer 5 and/or the polymer matrix 3 are further configured to be, for instance, pigmented with TiO₂ so as to achieve the best possible light scatter. Finally, the sensor elements 2 embedded in the polymer matrix or disposed on the base layer 5 may differ from one another by being, for instance, doped with two different luminescent dyes in order to be able to simultaneously measure different substances to be detected.

In order to achieve a particularly good adherence of the at least one sensor element 2, or the undoped polymer matrix 3, to the substrate 4, the substrate 4 is roughened prior to coating so as to obtain roughness structures comprising undercuts 14 as illustrated in FIG. 6. After the deposition of the sensor layer 2 or the undoped polymer matrix 3, the roughness structures are enclosed on all sides so as to achieve a stable mechanical anchorage in addition to the chemical adherence.

For the practical use of the sensor 1 according to the invention, the sensor 1 is held in a mounting cap 9 as illustrated in FIG. 5. The mounting cap 9 comprises a clamping means 10 for retaining the sensor 1 by the sensor 1 being clamped in the mounting clamp 10 by its end regions 11, which end regions are free of sensor elements 2 doped with luminescent dyes. By the sensor 1 being firmly held by the aid of the clamping means 10, any inadvertent detachment of the layers applied on the substrate 4, such as the base layer 5, the protecting layer 7 and the cover layer 8, will, moreover, be safely avoided.

On the rear side of the optochemical sensor 1, a schematically depicted fixing element 12 is further apparent, in which fixing element 12 an optical waveguide 13 is inserted to connect the optochemical sensor 1 to an optoelectronics or measuring electronics not illustrated. The optical waveguide 13 can, for instance, be an optical fiber, an optical fiber bundle, or a glass rod designed as an optical waveguide, or any other means suitable for transmitting light.

To sum up, it is noted that the insular arrangement of the sensor element(s) 2 in the polymer matrix 3 or layer 3 safely prevents bleeding of the sensor elements 2, and hence a deterioration of the sensor 1, even after multiple uses. At the same time, such an arrangement enables the provision of a cost-effective and efficiently measuring sensor 1, by which even mutually different gaseous or dissolved substances to be detected can be measured.

1. An optochemical sensor including a polymer matrix applied on a substrate and doped with a luminescent dye whose emissivity upon excitation with electromagnetic radiation by substances to be detected, such as gaseous or dissolved O₂, SO₂, H₂O₂, CO₂, nitrogen oxides, halogenated hydrocarbons, is variable, and which forms a sensor layer, which is further covered by a protecting, supporting and/or insulating layer permeable for the substance to be analyzed, wherein the sensor layer is formed by a layer comprising at least one insular sensor element, which at least one insular sensor element is covered by an undoped polymer matrix chemically corresponding to the polymer matrix of the sensor layer, and that a further layer corresponding to the undoped polymer matrix is provided between the substrate and the layer comprising the at least one sensor element.

2. The optochemical sensor according to claim 1, wherein the sensor layer is formed by a layer comprising a plurality of mutually separate sensor elements, which sensor elements are covered by an undoped polymer matrix chemically corresponding to the polymer matrix of the sensor layer.

3. The optochemical sensor according to claim 1, wherein the two layers of undoped polymer matrix are chemically and/or physically interconnected in the region encompassing the at least one sensor element.

4. The optochemical sensor according to claim 1, wherein the plurality of sensor elements is formed as a field of sensor elements comprising mutually equal distances, in particular punctiform sensor elements.

5. The optochemical sensor according to claim 4, wherein the field of sensor elements is comprised of at least two groups of sensor elements different in terms of the type of the doping with luminescent dye or the type of the matrix polymer.

6. The optochemical sensor according to claim 1, wherein the supporting, protecting and/or insulating layer is selected from macro- or micro-porous poly-tetrafluoroethylene membranes or nylon membranes, in particular having pore sizes ranging between 0.1 μm and 160 μm, preferably 0.1 μm and 30 μm, carbon fiber fabrics, special textile fiber fabrics, semi-permeable membranes of soluble polymers, in particular soluble, perfluorinated polymers, or a combination thereof.

7. The optochemical sensor according to claim 1, wherein the optical supporting, protecting and/or insulating layer is at least partially embedded in the undoped polymer matrix covering the layer comprising the sensors.

8. The optochemical sensor according to claim 1, wherein a cover layer is provided above the undoped polymer matrix or the supporting, protecting and/or insulating layer.

9. The optochemical sensor according to claim 8, wherein the cover layer is comprised of two cover layers, and that the supporting, protecting and/or insulating layer is disposed between the cover layers.

10. The optochemical sensor according to claim 9, wherein the cover layer is pigmented with soot, and that the inner cover layer is pigmented with TiO₂.

11. The optochemical sensor according to claim 1, wherein the cover layer is selected from silicones, partially fluorinated silicones and perfluorosilicones, coatings of soluble polymers, in particular soluble, perfluorinated polymers, or a combination thereof.

12. The optochemical sensor according to claim 1, wherein the cover layer is comprised of the same base material as the polymer matrix of the sensor.

13. The optochemical sensor according to claim 1, wherein an applied substrate having surface structures with undercuts is employed.

14. The optochemical sensor according to claim 1, wherein the optochemical sensor is held in a mounting cap.

15. The optochemical sensor according to claim 14, wherein the mounting cap is provided with a clamping or retaining element.

16. The optochemical sensor according to claim 11, wherein the mounting cap comprises a fixing element for an optical waveguide.

17. The optochemical sensor according to claim 1, wherein at least the polymer matrix of the sensor layer is comprised of soluble, amorphous, perfluorinated polymers such as polymers of substituted perfluoro-2-methylene-1,3-dioxolanes or perfluoro-(4-vinyloxy-1-butene), in particular poly[2,2,4-trifluoro-5-trifluoromethoxy-1,3-dioxol-co-tetra-fluoro-ethylene].

18. The optochemical sensor according to claim 1, wherein the cover layer and the sensor layer are comprised of soluble, amorphous, perfluorinated polymers such as polymers of substituted perfluoro-2-methylene-1,3-dioxolanes or perfluoro-(4-vinyloxy-1-butene), in particular poly[2,2,4-trifluoro-5-trifluoro-methoxy-1,3-dioxol-co-tetra-fluoro-ethylene].

19. (canceled)
